(19) United States
(12) Patent Application Publication
(10) Pub. No.: US 2010/0215238 A1
(43) Pub. Date: Aug. 26, 2010

(54) Method for Automatic Segmentation of Images

(76) Inventors: Yingli Lu, Toronto (CA); Perry Radau, Toronto (CA); Graham A. Wright, Toronto (CA)

Correspondence Address: QUARLES & BRADY LLP, 411 E. WISCONSIN AVENUE, SUITE 2040, MILWAUKEE, WI, 53202-4497, US

(21) Appl. No.: 12/710,733

(22) Filed: Feb. 23, 2010

Related U.S. Application Data
(60) Provisional application No. 61/154,556, filed on Feb. 23, 2009.

(51) Int. Cl. G06K 9/00

(52) U.S. Cl. 382/131

(57) ABSTRACT

A method for automatic left ventricle segmentation of cine short-axis magnetic resonance (MR) images that does not require manually drawn initial contours, trained statistical shape models, or gray-level appearance models is provided. More specifically, the method employs a roundness metric to automatically locate the left ventricle. Epicardial contour segmentation is simplified by mapping the pixels from Cartesian to approximately polar coordinates. Furthermore, region growing is utilized by distributing seed points around the endocardial contour to find the LV myocardium and, thus, the epicardial contour. This is a robust technique for images where the epicardial edge has poor contrast. A fast Fourier transform (FFT) is utilized to smooth both the determined endocardial and epicardial contours. In addition to determining endocardial and epicardial contours, the method also determines the contours of papillary muscles and trabeculations.

### CROSS-REFERENCE TO RELATED APPLICATIONS

This application claims the benefit of U.S. Provisional patent application Ser. No. 61/154,556 filed on Feb. 23, 2009, and entitled “Method for Automatic Segmentation of Images.”

### BACKGROUND OF THE INVENTION

The field of the invention is medical imaging methods and systems. More particularly, the invention relates to the segmentation of images acquired with a medical imaging system such as a magnetic resonance imaging (“MRI”) system, an x-ray computed tomography (“CT”) imaging system, or an ultrasound (“US”) imaging system.

When a substance such as human tissue is subjected to a uniform magnetic field (polarizing field B₀), the individual magnetic moments of the nuclei in the tissue attempt to align with this polarizing field, but precess about it in random order at their characteristic Larmor frequency. If the substance, or tissue, is subjected to a magnetic field (excitation field B₁) that is in the x-y plane and that is near the Larmor frequency, the net aligned moment, M_{z}, may be rotated, or “tipped”, into the x-y plane to produce a net transverse magnetic moment M_{xy}. A signal is emitted by the excited nuclei or “spins”, after the excitation signal B₁ is terminated, and this signal may be received and processed to form an image.

When utilizing these “MR” signals to produce images, magnetic field gradients (Gₓ, G_{y}, and G_{z}) are employed. Typically, the region to be imaged is scanned by a sequence of measurement cycles in which these gradients vary according to the particular localization method being used. The resulting set of received MR signals are digitized and processed to reconstruct the image using one of many well known reconstruction techniques.

The measurement cycle used to acquire each MR signal is performed under the direction of a pulse sequence produced by a pulse sequencer. Clinically available MRI systems store a library of such pulse sequences that can be prescribed to meet the needs of many different clinical applications. Research MRI systems include a library of clinically proven pulse sequences and they also enable the development of new pulse sequences.

The MR signals acquired with an MRI system are signal samples of the subject of the examination in Fourier space, or what is often referred to in the art as “k-space”. Each MR measurement cycle, or pulse sequence, typically samples a portion of k-space along a sampling trajectory characteristic of that pulse sequence. Most pulse sequences sample k-space in a raster scan-like pattern sometimes referred to as a “spin-warp”, a “Fourier”, a “rectilinear” or a “Cartesian” scan. The spin-warp scan technique employs a variable amplitude phase encoding magnetic field gradient pulse prior to the acquisition of MR spin-echo signals to phase encode spatial information in the direction of this gradient. In a two-dimensional implementation (“2DFT”), for example, spatial information is encoded in one direction by applying a phase encoding gradient, G_{y}, along that direction, and then a spin-echo signal is acquired in the presence of a readout magnetic field gradient, Gₓ, in a direction orthogonal to the phase encoding direction. The readout gradient present during the spin-echo acquisition encodes spatial information in the orthogonal direction. In a typical 2DFT pulse sequence, the magnitude of the phase encoding gradient pulse, G_{y}, is incremented, ΔG_{y}, in the sequence of measurement cycles, or “views” that are acquired during the scan to produce a set of k-space MR data from which an entire image can be reconstructed.

There are many other k-space sampling patterns used by MRI systems These include “radial”, or “projection reconstruction” scans in which k-space is sampled as a set of radial sampling trajectories extending from the center of k-space. The pulse sequences for a radial scan are characterized by the lack of a phase encoding gradient and the presence of a readout gradient that changes direction from one pulse sequence view to the next. There are also many k-space sampling methods that are closely related to the radial scan and that sample along a curved k-space sampling trajectory rather than the straight line radial trajectory.

An image is reconstructed from the acquired k-space data by transforming the k-space data set to an image space data set. There are many different methods for performing this task and the method used is often determined by the technique used to acquire the k-space data. With a Cartesian grid of k-space data that results from a 2D or 3D spin-warp acquisition, for example, the most common reconstruction method used is an inverse Fourier transformation (“2DFT” or “3DFT”) along each of the 2 or 3 axes of the data set. With a radial k-space data set and its variations, the most common reconstruction method includes “regridding” the k-space samples to create a Cartesian grid of k-space samples and then perform a 2DFT or 3DFT on the regridded k-space data set. In the alternative, a radial k-space data set can also be transformed to Radon space by performing a 1DFT of each radial projection view and then transforming the Radon space data set to image space by performing a filtered backprojection.

In a computed tomography system, an x-ray source projects a cone-shaped beam which is collimated to lie within an x-y plane of a Cartesian coordinate system, termed the “image plane.” The x-ray beam passes through the object being imaged, such as a medical patient, and impinges upon an array of radiation detectors. The intensity of the transmitted radiation is dependent upon the attenuation of the x-ray beam by the object and each detector produces a separate electrical signal that is a measurement of the beam attenuation. The attenuation measurements from all the detectors are acquired separately to produce what is called the “transmission profile,” or “attenuation profile,” or “projection.”

The source and detector array in a conventional CT system are rotated on a gantry within the imaging plane and around the object so that the angle at which the x-ray beam intersects the object constantly changes. The transmission profile from the detector array at a given angle is referred to as a “view,” and a “scan” of the object comprises a set of views made at different angular orientations during one revolution of the x-ray source and detector. In a 2D scan, data is processed to construct an image that corresponds to a two dimensional slice taken through the object. The prevailing method for reconstructing an image from 2D data is referred to in the art as the filtered backprojection technique. This image reconstruction process converts the attenuation measurements acquired during a scan into integers called “CT numbers” or “Hounsfield units”, which are used to control the brightness of a corresponding pixel on a display.

There are a number of modes in which ultrasound can be used to produce images of objects. The ultrasound transmitter may be placed on one side of the object and the sound transmitted through the object to the ultrasound receiver placed on the other side (“transmission” mode). With transmission mode methods, an image may be produced in which the brightness of each pixel is a function of the amplitude of the ultrasound that reaches the receiver (“attenuation” mode), or the brightness of each pixel is a function of the time required for the sound to reach the receiver (“time-of-flight” or “speed-of-sound” mode). In the alternative, the receiver may be positioned on the same side of the object as the transmitter and an image may be produced in which the brightness of each pixel is a function of the amplitude, or time-of-flight, of the ultrasound reflected from the object back to the receiver (“reflection,” “backscatter,” or “echo” mode).

There are a number of well known backscatter methods for acquiring ultrasound data. In the so-called “A-mode” method, an ultrasound pulse is directed into the object by the transducer and the amplitude of the reflected sound is recorded over a period of time. The amplitude of the echo signal is proportional to the scattering strength of the refractors in the object and the time delay is proportional to the range of the refractors from the transducer. In the so-called “B-mode” method, the transducer transmits a series of ultrasonic pulses as it is scanned across the object along a single axis of motion. The resulting echo signals are recorded as with the A-mode method and their amplitude is used to modulate the brightness of pixels on a display. The location of the transducer and the time delay of the received echo signals locates the pixels to be illuminated. With the B-mode method, enough data are acquired from which a two-dimensional image of the refractors can be reconstructed. Rather than physically moving the transducer over the subject to perform a scan it is more common to employ an array of transducer elements and electronically move an ultrasonic beam over a region in the subject.

To quantitatively assess global and regional cardiac function from magnetic resonance (MR) images, parameters such as ejection fraction, left ventricle volume, left ventricle mass, peak ejection rate, and filling rate are typically determined. However, calculations of these parameters depend upon an accurate delineation of both the endocardial and epicardial contours of the left ventricle (LV). Manual delineation is time-consuming and tedious, and also suffers from significant intra-observer and inter-observer variability. Moreover, in clinical practice the manual delineations are typically performed on images acquired during the end-diastolic (ED) and end-systolic (ES) phases. This serves as a limitation when calculating the aforementioned parameters because the ED and ES phases cannot be used to compute the peak ejection and filling rates. Thus, a fully automatic LV segmentation method that is operable on any cardiac phase is desirable.

Currently available automatic segmentation methods of the LV typically face four challenges. These include the overlap between the image intensity value distributions within the different cardiac regions, the lack of detailed edge information in the cardiac images, the shape variability of the endocardial and epicardial contours across slices and phases, and the inter-subject variability of the aforementioned problems. Although the segmentation results have improved, accurate left ventricle segmentation is still acknowledged as a difficult problem. A difficult challenge of left ventricle segmentation is the accurate delineation of the epicardial contours. Typically, the difficulty arises from ballooning of the epicardial contours at junctions between the myocardium, lung parenchyma, and sub-diaphragmatic tissues. This is because there is poor image contrast, that is, a small image intensity difference, between these tissue types.

It would therefore be desirable to have an automatic method for left ventricle segmentation that accurately produces an epicardial contour, despite the degree of image contrast between the epicardium and surrounding tissues.

### SUMMARY OF THE INVENTION

The present invention overcomes the aforementioned drawbacks by providing a method for image-driven automatic left ventricle (LV) segmentation of short axis (SAX) cine magnetic resonance (MR) images that is accurate and robust. In general, however, the provided method is also applicable to segment images acquired with an x-ray computed tomography (CT) system and an ultrasound imaging system. Moreover, the provided method is also applicable to segmenting anatomical regions other than the left ventricle, such as vessels including the internal carotid artery. The segmentation method does not require initialization by manually drawn contours, prior statistical shape models, or gray-level appearance models. Most model-based techniques require training with many manually drawn contours that are difficult to obtain. In addition, the variability of the shape due to pathology and the variability of the intensity-level of the left ventricle due to artifacts or scanning parameters complicate the training. The method is an image-driven method without any model assumptions. Therefore it is suitable for datasets with a wide range of anatomy, function, and image contrast, as required for routine clinical use.

It is an aspect of the invention to provide a method that simplifies the segmentation of the epicardial contour by mapping the pixels from Cartesian to approximately polar coordinates. By mapping the pixels from Cartesian to these “pseudo-polar” coordinates, the irregular, ring-shaped regions-of-interest are transformed to rectangular images or so-called “pseudo-polar maps”. In this way, the epicardial contour detection problem is simplified.

It is another aspect of the invention to provide a method for accurate segmentation of papillary and trabecular muscles, as well as endocardial and epicardial contours in all the phases. Clinical studies have employed different quantification methods for calculation of left ventricle volume, mass and ejection fraction by including or excluding papillary muscles and trabeculations in the ventricular cavity. Recent studies have shown that the papillary muscles and trabeculations have a significant impact on calculation of left ventricle volume and mass and ejection fraction; therefore, the method provides additional important options for daily clinical application.

It is yet another aspect of the invention to provide a method that includes the calculation of a roundness metric to automatically locate the left ventricle. Compared with previous ventricle localization techniques, the roundness metric method of the present invention is more straight-forward and computationally efficient, requiring only 0.013-0.085 seconds per subject. The method uses a roundness metric to distinguish the left ventricle on short axis images from other regions of bright intensity, such as the right ventricle. This is different from previous left ventricle localization methods that normally have two steps: first locating the entire heart, and then the left ventricle.

It is yet another aspect of the invention to provide a method that applies a fast Fourier transform (FFT) to smooth the endocardial and epicardial contours. Smoothing the contours by the FFT is a very fast and effective technique. The main merit of the FFT technique is to provide smoothed contours by removing outliers of the detected edge points without changing the overall shape.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a block diagram of a magnetic resonance imaging (“MRI”) system that employs the present invention;

FIG. 2 is a graphic representation of a steady-state free precession gradient recalled echo pulse sequence, which is employed when practicing an embodiment of the present invention;

FIG. 3A is a pictorial view of an x-ray computed tomography (“CT”) imaging system that employs the present invention;

FIG. 3B is a block diagram of the CT imaging system of FIG. 3A;

FIG. 4 is a block diagram of an ultrasound imaging system that employs the present invention;

FIG. 5 is a block diagram of a transmitter, which forms a part of the ultrasound system of FIG. 4;

FIG. 6 is a block diagram of a receiver, which forms a part of the ultrasound system of FIG. 4;

FIG. 7 is a flowchart setting forth the steps of an embodiment of the present invention;

FIG. 8 is a flowchart setting forth the steps of a method for determining the location of a left ventricle, which forms a part of the embodiment of the present invention represented in FIG. 7;

FIG. 9 is a flowchart setting forth the steps of a method for producing a contour of a left ventricle blood pool, which forms a part of the embodiment of the present invention represented in FIG. 7;

FIG. 10 is a flowchart setting forth the steps of a method for producing a contour of the endocardium of the left ventricle, which forms a part of the embodiment of the present invention represented in FIG. 7;

FIG. 11 is a flowchart setting forth the steps of a method for producing a contour of papillary muscles and trabeculations of the left ventricle, which forms a part of the embodiment of the present invention represented in FIG. 7;

FIG. 12 is a flowchart setting forth the steps of a method for producing a contour of the epicardium of the left ventricle, which forms a part of the embodiment of the present invention represented in FIG. 7;

FIG. 13A is a graphic representation of an exemplary cardiac image that is processed in accordance with the epicardial contour segmentation method represented in FIG. 12;

FIG. 13B is a graphic representation of an exemplary pseudo-polar map produced from the cardiac image of FIG. 13A, and in accordance with the epicardial contour segmentation method represented in FIG. 12;

FIG. 14A is a graphic representation of a step in a method for producing a pseudo-polar map in accordance with the epicardial contour segmentation method represented in FIG. 12; and

FIG. 14B is a graphic representation of a step in a method for producing a pseudo-polar map in accordance with the epicardial contour segmentation method represented in FIG. 12.

### DETAILED DESCRIPTION OF THE INVENTION

### Magnetic Resonance Imaging System

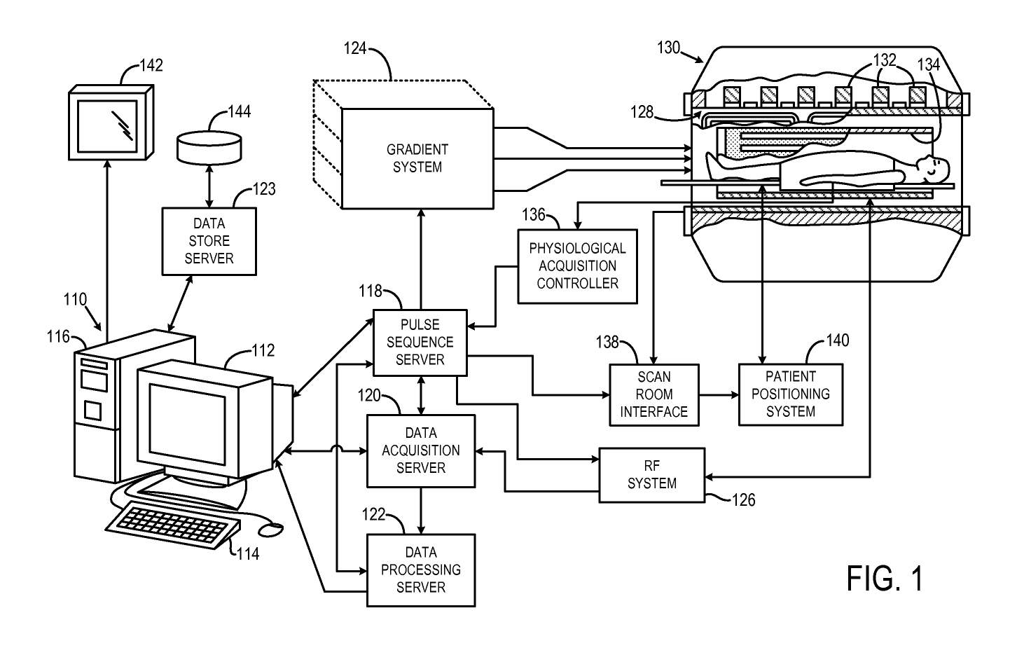

Referring particularly to FIG. 1, the preferred embodiment of the invention is employed in an MRI system. The MRI system includes a workstation 110 having a display 112 and a keyboard 114. The workstation 110 includes a processor 116 that is a commercially available programmable machine running a commercially available operating system. The workstation 110 provides the operator interface that enables scan prescriptions to be entered into the MRI system. The workstation 110 is coupled to four servers: a pulse sequence server 118; a data acquisition server 120; a data processing server 122, and a data store server 123. The workstation 110 and each server 118, 120, 122 and 123 are connected to communicate with each other.

The pulse sequence server 118 functions in response to instructions downloaded from the workstation 110 to operate a gradient system 124 and an RF system 126. Gradient waveforms necessary to perform the prescribed scan are produced and applied to the gradient system 124 that excites gradient coils in an assembly 128 to produce the magnetic field gradients Gₓ, G_{y}, and G_{z} used for position encoding MR signals. The gradient coil assembly 128 forms part of a magnet assembly 130 that includes a polarizing magnet 132 and a whole-body RF coil 134.

RF excitation waveforms are applied to the RF coil 134 by the RF system 126 to perform the prescribed magnetic resonance pulse sequence. Responsive MR signals detected by the RF coil 134 or a separate local coil (not shown in FIG. 1) are received by the RF system 126, amplified, demodulated, filtered and digitized under direction of commands produced by the pulse sequence server 118. The RF system 126 includes an RF transmitter for producing a wide variety of RF pulses used in MR pulse sequences. The RF transmitter is responsive to the scan prescription and direction from the pulse sequence server 118 to produce RF pulses of the desired frequency, phase and pulse amplitude waveform. The generated RF pulses may be applied to the whole body RF coil 134 or to one or more local coils or coil arrays (not shown in FIG. 1).

The RF system 126 also includes one or more RF receiver channels. Each RF receiver channel includes an RF amplifier that amplifies the MR signal received by the coil to which it is connected and a detector that detects and digitizes the I and Q quadrature components of the received MR signal. The magnitude of the received MR signal may thus be determined at any sampled point by the square root of the sum of the squares of the I and Q components:

M=\sqrt{I²+Q²} Eqn. (1);

and the phase of the received MR signal may also be determined:

$$φ = {tan}^{- 1} ( \frac{Q}{I} ) . \qquad Eqn . ( 2 )$$

The pulse sequence server 118 also optionally receives patient data from a physiological acquisition controller 136. The controller 136 receives signals from a number of different sensors connected to the patient, such as ECG signals from electrodes or respiratory signals from a bellows. Such signals are typically used by the pulse sequence server 118 to synchronize, or “gate”, the performance of the scan with the subject's respiration or heart beat.

The pulse sequence server 118 also connects to a scan room interface circuit 138 that receives signals from various sensors associated with the condition of the patient and the magnet system. It is also through the scan room interface circuit 138 that a patient positioning system 140 receives commands to move the patient to desired positions during the scan.

The digitized MR signal samples produced by the RF system 126 are received by the data acquisition server 120. The data acquisition server 120 operates in response to instructions downloaded from the workstation 110 to receive the real-time MR data and provide buffer storage such that no data is lost by data overrun. In some scans the data acquisition server 120 does little more than pass the acquired MR data to the data processor server 122. However, in scans that require information derived from acquired MR data to control the further performance of the scan, the data acquisition server 120 is programmed to produce such information and convey it to the pulse sequence server 118. For example, during prescans MR data is acquired and used to calibrate the pulse sequence performed by the pulse sequence server 118. Also, navigator signals may be acquired during a scan and used to adjust RF or gradient system operating parameters or to control the view order in which k-space is sampled. And, the data acquisition server 120 may be employed to process MR signals used to detect the arrival of contrast agent in a magnetic resonance angiography (MRA) scan. In all these examples the data acquisition server 120 acquires MR data and processes it in real-time to produce information that is used to control the scan.

The data processing server 122 receives MR data from the data acquisition server 120 and processes it in accordance with instructions downloaded from the workstation 110. Such processing may include, for example: Fourier transformation of raw k-space MR data to produce two or three-dimensional images; the application of filters to a reconstructed image; the performance of a backprojection image reconstruction of acquired MR data; the calculation of functional MR images; the calculation of motion or flow images, etc.

Images reconstructed by the data processing server 122 are conveyed back to the workstation 110 where they are stored. Real-time images are stored in a data base memory cache (not shown) from which they may be output to operator display 112 or a display 142 that is located near the magnet assembly 130 for use by attending physicians. Batch mode images or selected real time images are stored in a host database on disc storage 144. When such images have been reconstructed and transferred to storage, the data processing server 122 notifies the data store server 123 on the workstation 110. The workstation 110 may be used by an operator to archive the images, produce films, or send the images via a network to other facilities.

In an embodiment of the present invention, magnetic resonance (“MR”) image data is acquired from a subject's heart using so-called “cine” magnetic resonance imaging (MRI). In cine MRI, a time series of image data is acquired with temporal resolution sufficient for a time series of image frames that faithfully depict the subject to be reconstructed. An exemplary pulse sequence employed for cine MRI includes a so-called steady-state free precession (“SSFP”) gradient echo pulse sequence. Alternatively, other pulse sequence can be employed; however, those pulse sequences that provide a significant image contrast between blood and myocardial tissue are preferred.

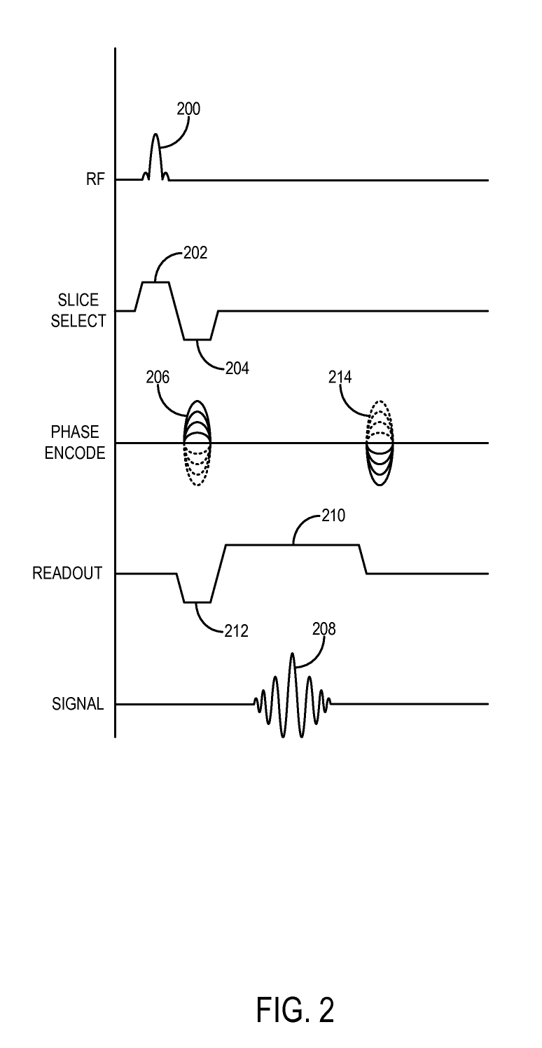

Referring particularly to FIG. 2, a pulse sequence timing diagram for an SSFP gradient echo pulse sequence is shown. The pulse sequence begins by applying a radiofrequency (RF) excitation pulse 200 in the presence of a slice selective gradient 202. The frequency content of the excitation pulse 200 and the amplitude of the slice selective gradient pulse 202 are selected to produce transverse magnetization in a desired slice location in the subject. In an embodiment of the present invention, the slice selective gradient 202 is stepped through a plurality of values such that a series of along the short-axis (SAX) of the subject's heart are acquired. For example, six to twelve different slice locations are selected between the atrioventricular ring and the apex of the heart. In such an exemplary scanning protocol, a slice thickness of 8 millimeters (“mm”) with a gap of 8 mm between adjacent slices is chosen. The slice selective gradient 202 includes a rephasing lobe 204, which is applied to rephase the spins in preparation for the phase encoding and readout gradients.

Phase encoding of the transverse magnetization is performed by playing out a phase encoding gradient 206 in the presence of the rephasing lobe 204 of the slice selective gradient 202. As is well known to those skilled in the art, the magnitude of the phase encoding gradient pulse 206 is stepped through a series of positive and negative values during the scan, but each is set to one value during each repetition time (TR) period. As is also well known in the art, the magnitude of a phase encoding gradient pulse is determined by the integral of its amplitude over its duration (i.e., its area). In most pulse sequences the duration is kept constant and the phase encoding pulse magnitude is stepped through its value by changing its amplitude.

After phase encoding of the transverse magnetization, the MR signal 208 is readout in the presence of a readout gradient 210. This readout gradient 210 is preceded by a negative gradient lobe 212 to produce the gradient refocused MR echo signal 208 in the usual fashion. The pulse sequence is then concluded by the application of a rewinder gradient pulse 214 to prepare the magnetization for the next repetition of the pulse sequence, which follows immediately. As is known to those skilled in the art, the rewinder pulse 214 refocuses transverse magnetization in preparation for the next repetition of the pulse sequence. The rewinder pulse 214 is equal in magnitude, but opposite in polarity, with the phase encoding pulse 206. The cancellation of the phase encoding supplied by the rewinder gradient 214 ensures that the echo produced in the next repetition of the pulse sequence is not altered by a different phase encoding.

To mitigate image artifacts resulting from respiratory motion of the subject, image data is acquired during a breath-hold on the order of 10-15 seconds. In such an exemplary data acquisition scheme, image data corresponding to twenty different cardiac phases is acquired from each slice location during each breath-hold.

### X-Ray Computed Tomography Imaging System

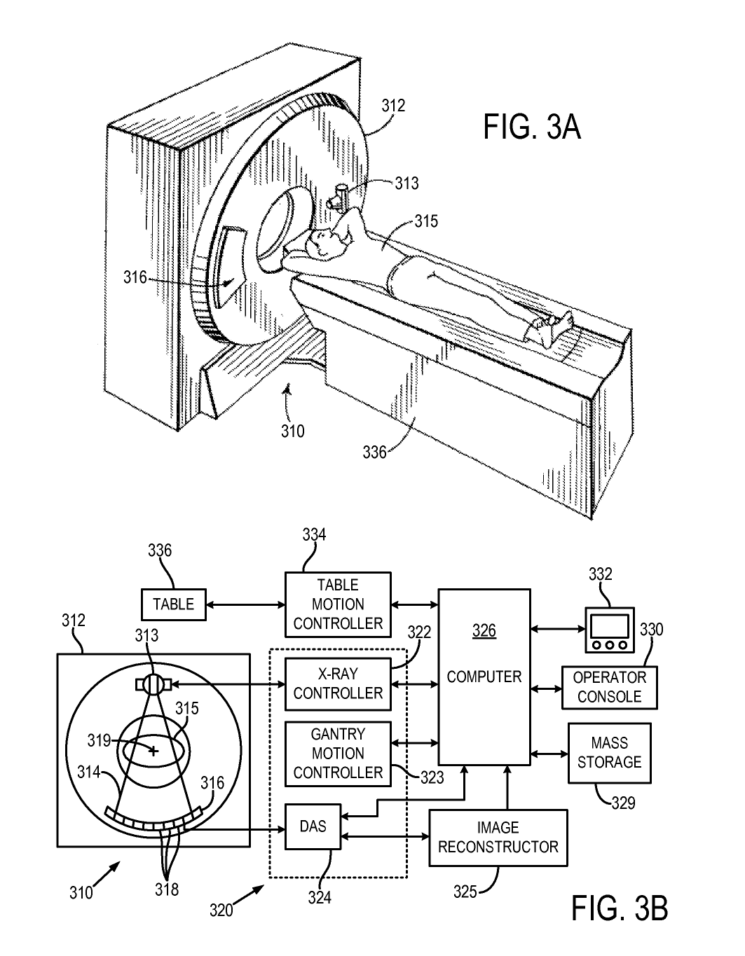

The present invention is also applicable to segmenting images acquired with x-ray computed tomography cardiac imaging. With initial reference to FIGS. 3A and 3B, an x-ray computed tomography (CT) imaging system 310 includes a gantry 312 representative of a “third generation” CT scanner. Gantry 312 has an x-ray source 313 that projects a fan-beam, or cone-beam, of x-rays 314 toward a detector array 316 on the opposite side of the gantry. The detector array 316 is formed by a number of detector elements 318 which together sense the projected x-rays that pass through a medical patient 315. Each detector element 318 produces an electrical signal that represents the intensity of an impinging x-ray beam and hence the attenuation of the beam as it passes through the patient. During a scan to acquire x-ray projection data, the gantry 312 and the components mounted thereon rotate about a center of rotation 319 located within the patient 315.

The rotation of the gantry and the operation of the x-ray source 313 are governed by a control mechanism 320 of the CT system. The control mechanism 320 includes an x-ray controller 322 that provides power and timing signals to the x-ray source 313 and a gantry motor controller 323 that controls the rotational speed and position of the gantry 312. A data acquisition system (DAS) 324 in the control mechanism 320 samples analog data from detector elements 318 and converts the data to digital signals for subsequent processing. An image reconstructor 325, receives sampled and digitized x-ray data from the DAS 324 and performs high speed image reconstruction. The reconstructed image is applied as an input to a computer 326 which stores the image in a mass storage device 328.

The computer 326 also receives commands and scanning parameters from an operator via console 330 that has a keyboard. An associated display 332 allows the operator to observe the reconstructed image and other data from the computer 326. The operator supplied commands and parameters are used by the computer 326 to provide control signals and information to the DAS 324, the x-ray controller 322 and the gantry motor controller 323. In addition, computer 326 operates a table motor controller 334 which controls a motorized table 336 to position the patient 315 in the gantry 312.

### Ultrasound Imaging System

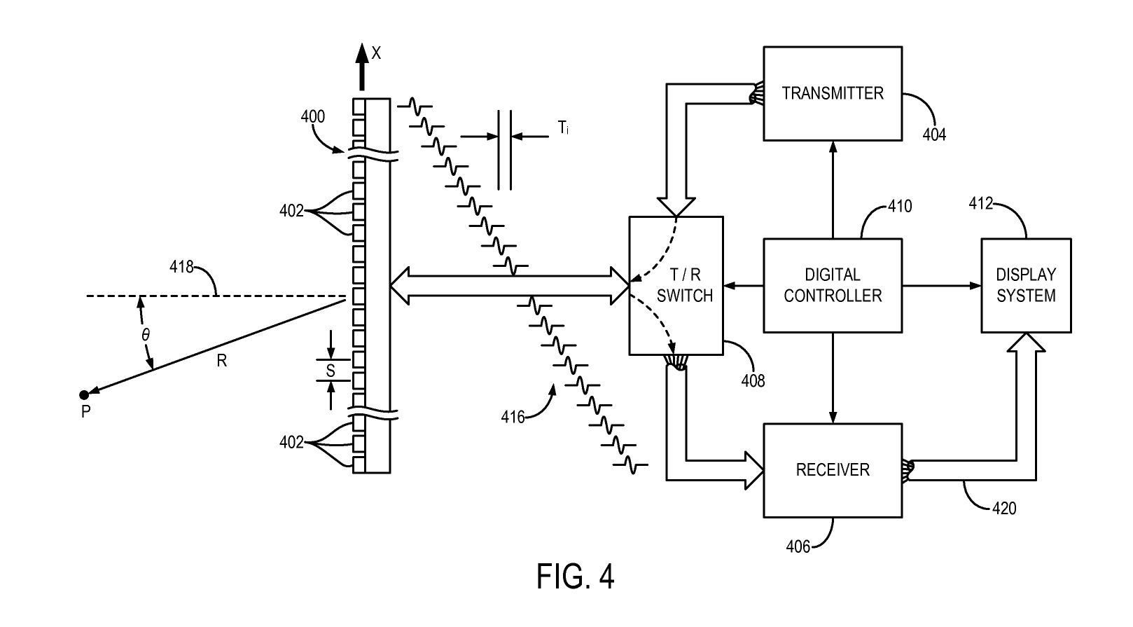

Referring particularly to FIG. 4, an ultrasonic imaging system includes a transducer array 400 comprised of a plurality of separately driven elements 402 which each produce a burst of ultrasonic energy when energized by a pulse produced by a transmitter 404. The ultrasonic energy reflected back to the transducer array 400 from the subject under study is converted to an electrical signal by each transducer element 402 and applied separately to a receiver 406 through a set of switches 408. The transmitter 404, receiver 406, and the switches 408 are operated under the control of a digital controller 410 responsive to the commands input by the human operator. A complete scan is performed by acquiring a series of echoes in which the switches 408 are set to their transmit position, the transmitter 404 is gated on momentarily to energize each transducer element 402, the switches 408 are then set to their receive position, and the subsequent echo signals produced by each transducer element 402 are applied to the receiver 406. The separate echo signals from each transducer element 402 are combined in the receiver 406 to produce a single echo signal which is employed to produce a line in an image on a display system 412.

The transmitter 404 drives the transducer array 400 such that the ultrasonic energy produced is directed, or steered, in a beam. A B-scan can therefore be performed by moving this beam through a set of angles from point-to-point rather than physically moving the transducer array 400. To accomplish this the transmitter 404 imparts a time delay, to the respective pulses 416 that are applied to successive transducer elements 402. If the time delay is zero Tᵢ=0, all the transducer elements 402 are energized simultaneously and the resulting ultrasonic beam is directed along an axis 418 normal to the transducer face and originating from the center of the transducer array 400. As the time delay, T, is increased, the ultrasonic beam is directed downward from the central axis 418 by an angle, θ. The relationship between the time delay increment, T, added successively to each i^{th} signal from one end of the transducer array (i=1) to the other end (i=n) is given by the following relationship:

$${T}_{i} = ( i - \frac{( n - 1 )}{2} ) ( \frac{S sin ( θ )}{c} ) + {( i - \frac{( n - 1 )}{2} )}^{2} ( \frac{{S}^{2} cos ( 2 θ )}{2 Rc} ) + {T}_{0} ; \qquad Eqn . ( 3 )$$

where S is an equal spacing between centers of adjacent transducer elements 402, c is the velocity of sound in the object under study, R is a range at which the transmit beam is to be focused, and T₀ is a delay offset that insures that all calculated values, Tᵢ, are positive values.

The first term in this expression steers the beam in the desired angle, θ, and the second is employed when the transmitted beam is to be focused at a fixed range. A sector scan is performed by progressively changing the time delays, Tᵢ, in successive excitations. The angle, θ, is thus changed in increments to steer the transmitted beam in a succession of directions. When the direction of the beam is above the central axis 418, the timing of the pulses 416 is reversed, but the above formula still applies.

Referring still to FIG. 4, the echo signals produced by each burst of ultrasonic energy emanate from reflecting objects located at successive positions, R, along the ultrasonic beam. These are sensed separately by each segment 402 of the transducer array 400 and a sample of the magnitude of the echo signal at a particular point in time represents the amount of reflection occurring at a specific range, R. Due to the differences in the propagation paths between a focal point, P, and each transducer element 402, however, these echo signals will not occur simultaneously and their amplitudes will not be equal. The function of the receiver 406 is to amplify and demodulate these separate echo signals, impart the proper time delay to each and sum them together to provide a single echo signal which accurately indicates the total ultrasonic energy reflected from each focal point, P, located at successive ranges, R, along the ultrasonic beam oriented at the angle, θ.

Under the direction of the digital controller 410, the receiver 406 provides delays during the scan such that the steering of the receiver 406 tracks with the direction of the beam steered by the transmitter 404 and it samples the echo signals at a succession of ranges and provides the proper delays to dynamically focus at points, P, along the beam. Thus, each emission of an ultrasonic pulse results in the acquisition of a series of data points which represent the amount of reflected sound from a corresponding series of points, P, located along the ultrasonic beam.

The display system 412 receives the series of data points produced by the receiver 406 and converts the data to a form producing the desired image. For example, if an A-scan is desired, the magnitude of the series of data points is merely graphed as a function of time. If a B-scan is desired, each data point in the series is used to control the brightness of a pixel in the image, and a scan comprised of a series of measurements at successive locations along the length of the transducer 400 for linear array mode imaging, or steering angles for phased array mode imaging, is performed to provide the data necessary for display.

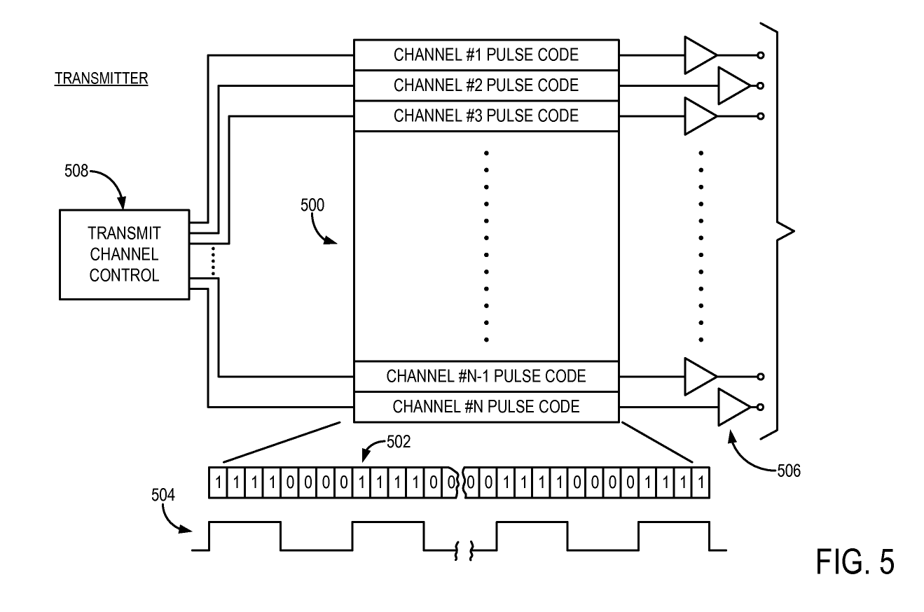

Referring particularly to FIG. 5, the transmitter 404 includes a set of channel pulse code memories which are indicated collectively at 500. Each pulse code memory 500 stores a bit pattern 502 that determines the frequency of the ultrasonic pulse 504 that is to be produced. This bit pattern is read out of each pulse code memory 500 by a master clock and applied to a driver 506 which amplifies the signal to a power level suitable for driving the transducer 400. In the example shown in FIG. 5, the bit pattern is a sequence of four “1” bits alternated with four “0” bits to produce a 5 megahertz (“MHz”) ultrasonic pulse 504. The transducer elements 402 to which these ultrasonic pulses 504 are applied respond by producing ultrasonic energy.

As indicated above, to steer the transmitted beam of the ultrasonic energy in the desired manner, the pulses 504 for each of the N channels must be produced and delayed by the proper amount. These delays are provided by a transmit control 508 which receives control signals from the digital controller 410. When the control signal is received, the transmit control 508 gates a clock signal through to the first transmit channel 500. At each successive delay time interval thereafter, the clock signal is gated through to the next channel pulse code memory 500 until all the channels to be energized are producing their ultrasonic pulses 504. Each transmit channel 500 is reset after its entire bit pattern 502 has been transmitted and the transmitter 404 then waits for the next control signal from the digital controller 410. By operating the transmitter 404 in this manner, ultrasonic energy can be focused on a focal point, P, when practicing the herein described method. This focal point can be steered electronically with the appropriate changes to the timing delays provided by the transmit control 508. The term “focal point,” as referred to herein, includes not only a single point object in the usual sense, but also a general region-of-interest to which ultrasound energy is delivered in a substantially focused manner.

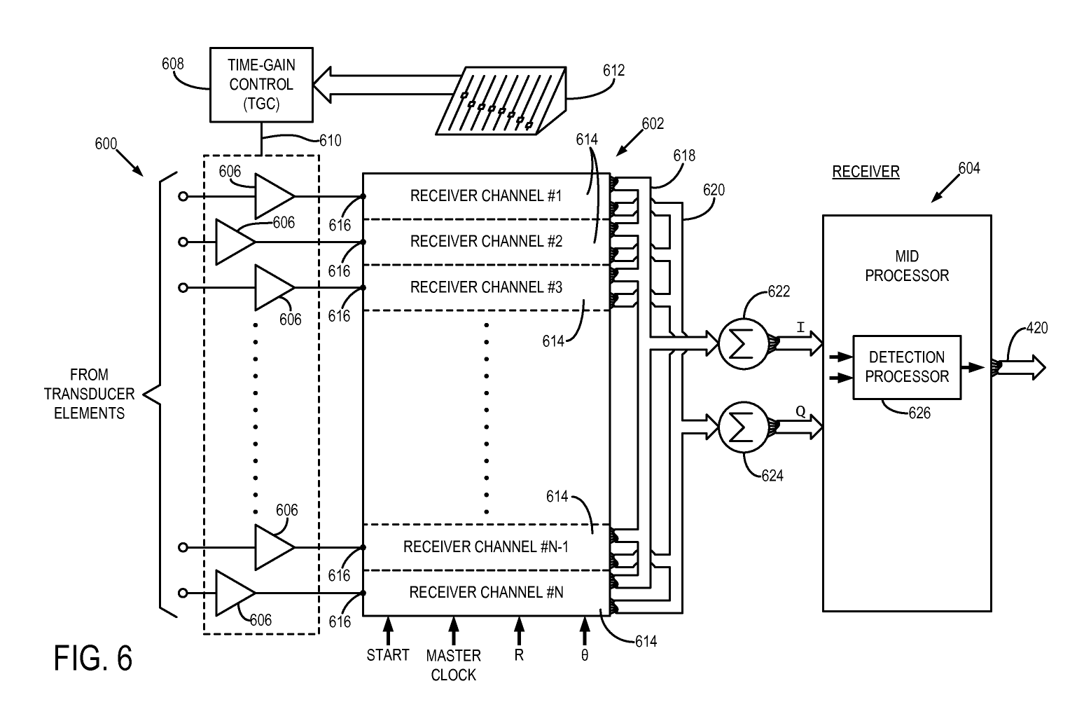

Referring particularly to FIG. 6, the receiver 406 is comprised of three sections: a time-gain control (“TGC”) section 600, a beam forming section 602, and a mid processor 604. The time-gain control section 600 includes an amplifier 606 for each of the N receiver channels and a time-gain control circuit 608. The input of each amplifier 606 is connected to a respective one of the transducer elements 402 to receive and amplify the echo signal which it receives. The amount of amplification provided by the amplifiers 606 is controlled through a control line 610 that is driven by the time-gain control circuit 608. As is well known in the art, as the range of the echo signal increases, its amplitude is diminished. As a result, unless the echo signal emanating from more distant reflectors is amplified more than the echo signal from nearby reflectors, the brightness of the image diminishes rapidly as a function of range, R. This amplification is controlled by the operator who, for example, manually sets TGC linear potentiometers 612 to values which provide a relatively uniform brightness over the entire range of the scan. The time interval over which the echo signal is acquired determines the range from which it emanates, and this time interval is divided into segments by the TGC control circuit 608. The settings of the potentiometers are employed to set the gain of the amplifiers 606 during each of the respective time intervals so that the echo signal is amplified in ever increasing amounts over the acquisition time interval.

The beam forming section 602 of the receiver 406 includes N separate receiver channels 614. Each receiver channel 614 receives the analog echo signal from one of the TGC amplifiers 606 at an input 616, and it produces a stream of digitized output values on an I bus 618 and a Q bus 620. Each of these I and Q values represents a sample of the echo signal envelope at a specific range, R. These samples have been delayed in the manner described above such that when they are summed at summing points 622 and 624 with the I and Q samples from each of the other receiver channels 614, they indicate the magnitude and phase of the echo signal reflected from a point, P, located at range, R, on the ultrasonic beam.

Referring still to FIG. 6, the mid processor section 604 receives the beam samples from the summing points 622 and 624. The I and Q values of each beam sample is a digital number which represents the in-phase and quadrature components of the magnitude of the reflected sound from a point, P. The mid processor 604 can perform a variety of calculations on these beam samples, where choice is determined by the type of image to be reconstructed. For example, if a conventional magnitude image is to be produced, a detection processor indicated at 626 is implemented in which a digital magnitude, M, is calculated from each beam sample according to:

M=\sqrt{I²+Q²} Eq (4);

and output at 420 (FIGS. 4 and 6).

The detection processor 626 may also implement correction methods that, for example, examine the received beam samples and calculate corrective values that can be used in subsequent measurements by the transmitter 404 and receiver 406 to improve beam focusing and steering. Such corrections are necessary, for example, to account for the non-homogeneity of the media through which the sound from each transducer element travels during a scan.

### Automatic Segmentation of Cardiac Images

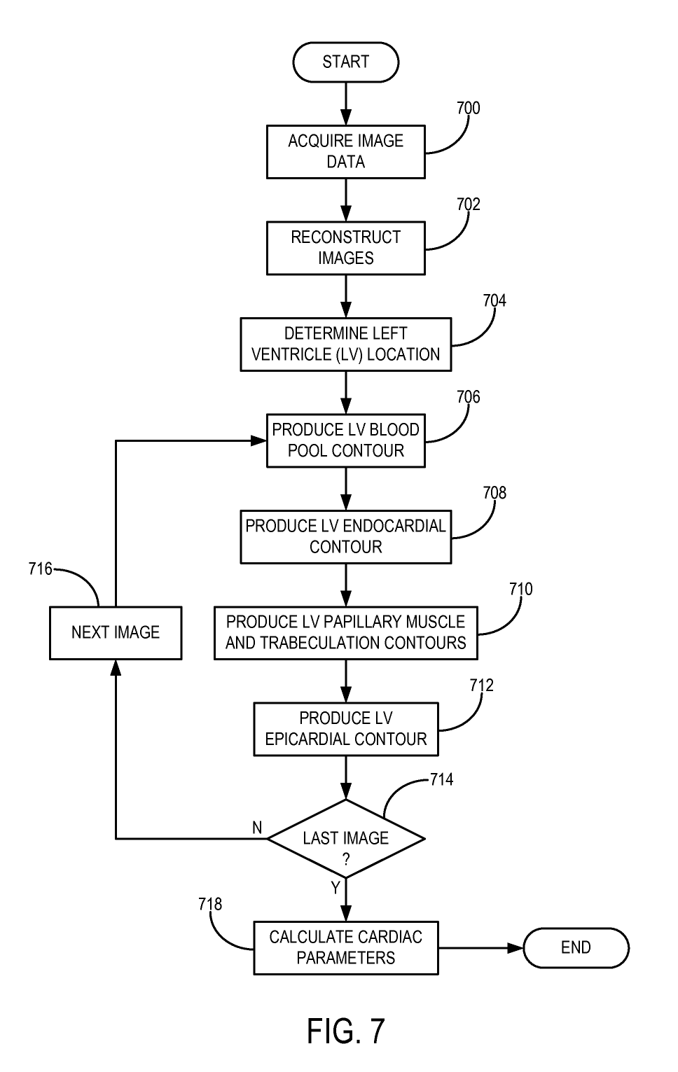

Referring now to FIG. 7, in one embodiment of the present invention, an automatic segmentation of cardiac images begins by acquiring image data with a medical imaging system, as indicated at step 700. In one embodiment of the present invention, the image data is acquired with an MRI system using an SSFP pulse sequence, such as the one described above with respect to FIG. 2. In the alternative, the image data can be acquired with an x-ray computed tomography system, such as the one described above with respect to FIG. 3, or with an ultrasound imaging system, such as the one described above with respect to FIG. 4. As image data is being acquired, information indicative of the subject's cardiac cycle is also obtained. For example, as MR image data is acquired an electrocardiogram (ECG) is obtained from the subject and the timing of the R-wave peak is recorded.

After all of the desired image data has been acquired from the subject, a series of images are reconstructed from the acquired data, as indicated at step 702. During the image reconstruction step, the cardiac cycle information previously obtained is utilized to reconstruct images indicative of a selected cardiac phase. Each selected cardiac phase is determined from the time at which the corresponding image data was acquired with respect to the occurrence of the R-wave peak. In this manner, an exemplary series of images includes six to twelve different images, each corresponding to a particular slice location, for each of twenty different cardiac phases. Exemplary cardiac phase images include images of end-diastole and end-systole.

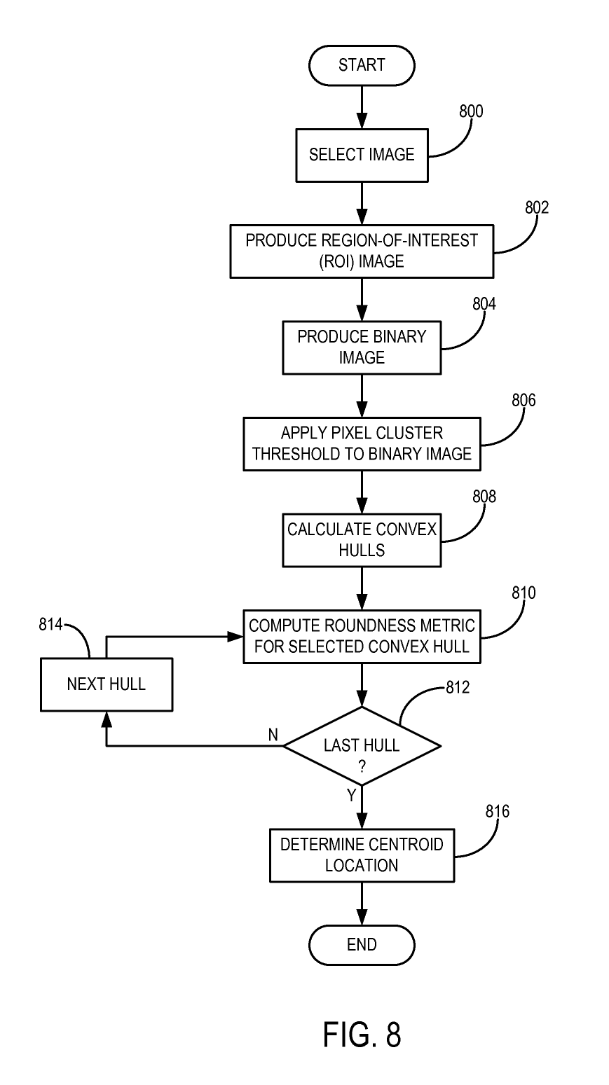

When all of the desired images have been reconstructed, segmentation of the images begins by first determining the location of the left ventricle, as indicated at step 704. Referring now particularly to FIG. 8, the location of the left ventricle is determined by first selecting an image from which the determination is to be made, as indicated at step 800. An exemplary selected image is one having a slice location at the mid-cavity level and corresponding to the end-diastolic (“ED”) cardiac phase. However, in general, any image in which the heart is substantially centered can be utilized to determine the left ventricle location. A reasonable assumption is made that the location of the left ventricle does not vary significantly from slice to slice and from cardiac phase to cardiac phase; therefore, determining the location of the left ventricle in this one selected image provides sufficient information for the segmentation of all images in the reconstructed series. A region-of-interest (ROI) image is next produced from the selected image, as indicated at step 802. A predetermined ROI is centered in the selected image. For example, a square ROI having a length and width of 110 pixels is employed. In general, the left ventricle (LV) is substantially centered in the mid-cavity slice image of the ED cardiac phase; therefore, by centering the ROI in the image frame, the LV is included in the ROI. The ROI image is thus an image including only those pixels contained within the ROI.

Using the produced ROI image, a binary image is produced next, as indicated at step 804. In general, Otsu's method is utilized to reduce the gray-scale ROI image to a binary image; however, in the alternative, other thresholding techniques may be employed to produce the binary image. For example, a simple image intensity threshold value can be selected and each pixel in the ROI image having an image intensity above the threshold is set to a value of one in the binary image, and each pixel having an image intensity value below the threshold is given a value of zero in the binary image. After the binary image is produced, pixel clusters smaller than a user-defined threshold size are removed from the binary image, as indicated at step 806. More specifically, clusters of pixels having binary values equal to one are removed from the binary image if the cluster size is below a threshold value. An exemplary pixel cluster threshold size is 40 pixels. In this manner, binary values for pixels in a cluster of pixels having binary values of one, and which contain fewer than 40 pixels, are all set to zero. This step is performed in order to improve the accuracy of the segmentation method.

After the undesired pixel clusters are removed from the binary image, a convex hull is calculated for the remaining pixel clusters, as indicated at step 808. Algorithms for calculating the convex hull of an object are well known in the art, and any such algorithm is applicable for the present method. For each convex hull produced in step 808, a roundness metric is calculated, as indicated at step 810. Such a roundness metric, R, has the following form:

$$R = \frac{4 π A}{{P}^{2 }} ; \qquad Eqn . ( 5 )$$

where A is the area bounded by the selected convex hull and P is the perimeter length of the selected convex hull. For a purely circular object, the roundness metric equals one. A determination is made at decision block 812 whether a roundness metric for each of the convex hulls created in step 808 has been calculated. If not, the next convex hull is selected at step 814 and the roundness metric, R, for that convex hull is calculated. After the roundness metric, R, for each convex hull has been calculated in the aforementioned manner, the location of the left ventricle is determined, as indicated at step 816. The left ventricle is substantially circular and, therefore, corresponds to the convex hull having the largest roundness metric. This convex hull is selected and its centroid calculated. The (x,y) coordinates of the centroid of the convex hull having the largest roundness metric is thus recorded as the location of the left ventricle.

In the alternative to the above-described method for determining the location of the left ventricle, a Fourier analysis across cardiac phases can also be employed to determine the left ventricle location. For example, cardiac motion could be detected by Fourier analysis across the cardiac phases, after which the largest moving blood pool could be isolated. The center of this largest moving blood pool object would subsequently be calculated and selected as the location of the left ventricle. Similarly, another alternative method for determining the location of the left ventricle includes an intensity-based image registration algorithm that is applied to determine the substantially optimal rotation, translation, and scaling parameters to match the reconstructed images to a reference cardiac image from the middle of the ventricle. Having determined the registration transform, and knowing the location of the blood pool from the reference cardiac image, the centroid of the left ventricle is calculated. This technique is applied to all cardiac phases of the middle slice and the average determines the best estimate of the blood pool centroid.

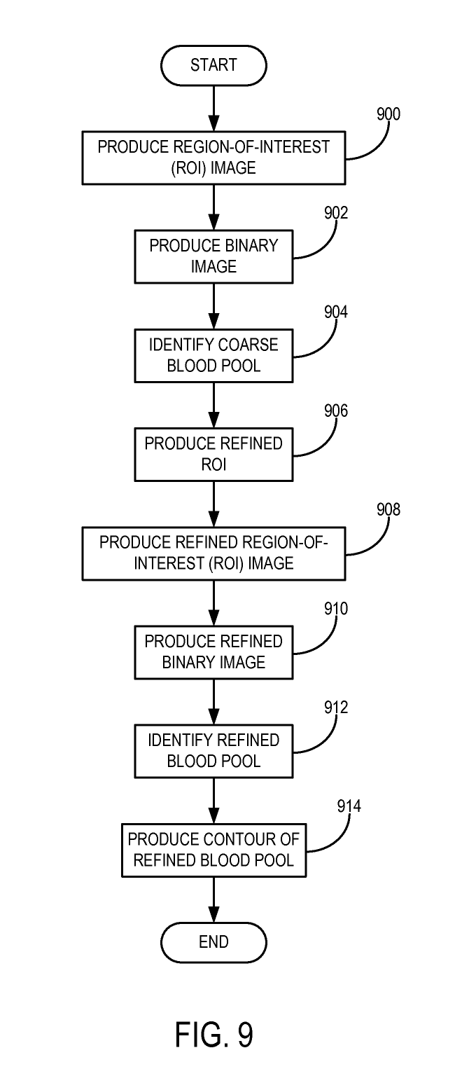

Referring again to FIG. 7, after the location of the left ventricle has been determined, the segmentation of each image reconstructed in step 702 proceeds. First, the contour of the left ventricle blood pool is produced, as indicated at step 706. Referring particularly now to FIG. 9, a method for producing a contour of the left ventricle blood pool begins by producing a region-of-interest (ROI) image, as indicated at step 900. Similar to the ROI image produced when determining the location of the left ventricle, the ROI image produced when producing the contour of the blood pool includes positioning a predetermined ROI over the selected image. An exemplary ROI is a 110-by-110 pixel square ROI. The predetermined ROI is centered over the left ventricle centroid calculated above in step 704; thus, the ROI image produced in step 900 includes those pixels in the selected image that are contained in the predetermined ROI as centered about the left ventricle centroid. After the ROI image is produced, a binary image is subsequently producing, as indicated at step 902. Similar to the method described above with respect to determining the left ventricle location, the binary image is produced by thresholding the ROI image using, for example, Otsu's method.

Subsequently, a coarse blood pool is identified in the binary image, as indicated at step 904. This is achieved by finding the cluster of pixels in the binary image that has the substantially maximum overlap with a predefined mask. In an embodiment of the present invention, the predefined mask is a 20-by-20 pixel square having binary values equal to one. The cluster of pixels identified in this manner remain unchanged in the binary image, while pixels not contained in the identified cluster are “turned off,” or set to binary values of zero. After the blood pool object is identified in the binary image, it is utilized to produce a refined region-of-interest, as indicated at step 906. Such a refined ROI is produced, for example, by dilating the identified coarse blood pool using the following operation:

I⊕B={xεR²|Bₓ∩I≠Ø} Eqn. (6);

where I is the binary image containing only the coarse blood pool; B is a structuring element; x is a pixel location of a pixel in the binary image; Bₓ is the translation of the structuring element, B, such that the structuring element, B, is centered at the pixel location, x; and Ø indicates the empty set. An exemplary structuring element, B, for use when practicing an embodiment of the present invention is a circular structuring element having a radius of 20 pixels. The resulting binary image is employed to identify a refined ROI that is utilized to produce a refined ROI image, as indicated at step 908. This refined ROI image is produced, for example, by multiplying the ROI image produced in step 902 by the binary image corresponding to the refined ROI produced in step 906. In this manner, only the pixels that overlap the dilated blood pool object remain in the refined ROI image.

Similar to the processing of the ROI image produced in step 902, a refined binary image is produced from the refined ROI image, as indicated in step 910. As before, this is achieved using Otsu's method to threshold the refined ROI image. After the refined binary image is produced, a refined blood pool is identified therein, as indicated at step 912. This step proceeds in the aforementioned manner for identifying the coarse blood pool, in that a cluster of pixels having a substantially maximum overlap with a predefined mask is identified as the refined blood pool. In the alternative to the aforementioned method, the left ventricle blood pool can be determined using a region growing method, starting from the left ventricle centroid calculated in step 816. Using such a method, all of the pixels in the acquired image having substantially similar image intensity values are identified as belonging to the blood pool object. Subsequently, the refined blood pool contour is produced, as indicated at step 914. Methods for determining the contour of an object in a binary image are well known in the art, and any such method can be employed to produce the contour of the refined blood pool.

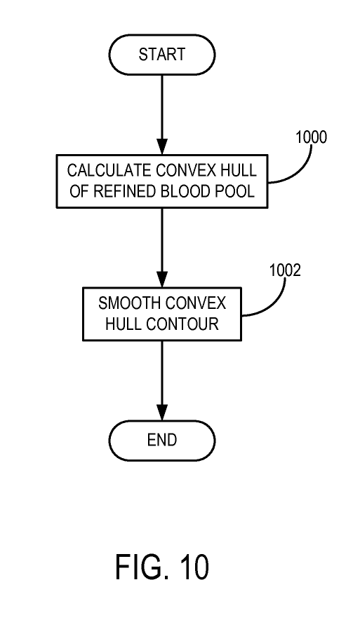

Referring again to FIG. 7, after the left ventricle blood pool contour is produced, the endocardial contour for the left ventricle is produced, as indicated at step 708. Referring particularly now to FIG. 10, a method for producing a contour of the left ventricle endocardium begins, at step 1000, by calculating the convex hull of the refined blood pool identified in step 912. This convex hull represents the inner boundary of the left ventricular chamber. As such, it is indicative of the endocardial wall of the left ventricle. After the convex hull is calculated, it is smoothed to produce the contour of the endocardial contour, as indicated at step 1002. This smoothing step is carried out by performing a one-dimensional fast Fourier transform (1D FFT) along each of the x- and y-axes of the convex hull. In an embodiment of the invention, only the four lowest frequency components of each 1D FFT are kept. Smoothing the contour using such an approach is a fast method that provides the smoothed contours by removing outliers of the detected edge points without changing the overall shape of the contour. Alternatively, the endocardial contour can be determined by an active contour method. In such a method, a small circle contour is employed as a “seed”, after which the active contour iteratively balloons outward until it “snaps” on to the edge defined by the endocardium. Using the appropriate parameters, such a method will result in a smooth contour of the endocardium.

Referring again to FIG. 7, contours for the papillary muscles and trabeculations in the left ventricle are produced next, as indicated at step 710. Clinical cardiac studies often employ different quantification methods for the calculation of parameters such as left ventricle volume, mass fraction, and ejection fraction. There is debate in the literature as to whether it is best to include or exclude the papillary muscles and trabeculations in the ventricular cavity, and recent studies have shown that the papillary muscles and trabeculations have a significant impact on the calculation of the aforementioned parameters. Therefore, the following embodiment of the invention provides additional information for the calculation of cardiac parameters important for clinical assessments.

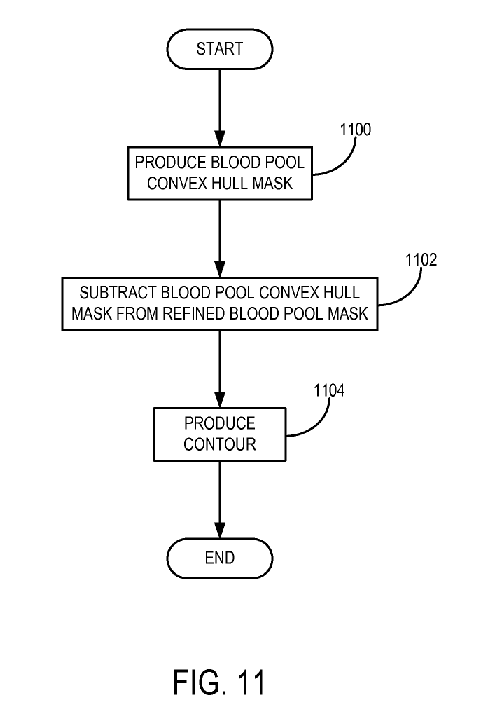

Referring now to FIG. 11, a method for producing a contour of the papillary muscles and trabeculations in the left ventricle begins producing a blood pool convex hull mask, as indicated at step 1100. This is achieved, for example, by using the convex hull produced above in step 1000 as a boundary for a cluster of pixels in a binary image mask. Specifically, for those pixels bounded by the convex hull their binary image values are set to one, while those pixels outside of the boundary are given binary image values of zero. After the blood pool convex hull mask is produced, the papillary muscles and trabeculations are identified, as indicated at step 1102. For this, the blood pool convex hull mask is subtracted from the refined blood pool binary image produced when identifying the refined blood pool in step 912. The result of this subtraction leaves binary image pixel clusters corresponding to the papillary muscles and trabeculations. Subsequently, the contour of these pixel clusters is produced in step 1104, such a contour being representative of the papillary muscles and trabeculations in the left ventricle.

In the alternative, the trabeculations can be identified by subtracting an image matching the blood pool boundary from the image representing the endocardial border. Additionally, the papillaries could be alternatively identified by finding clusters of pixels within the blood pool that have significantly different image intensity values.

Referring again to FIG. 7, the epicardial contour for the left ventricle is produced next, as indicated at step 712. In general, a region growing method is employed using many seed points distributed around the previously produced endocardial contour. These regions are subsequently combined to define the left ventricular myocardium. From this result, the epicardial contour is produced. Accurate determination of the epicardial contour is often the most difficult image processing challenge due to the low image contrast and poor edge definition; however, the following method addresses these challenges.

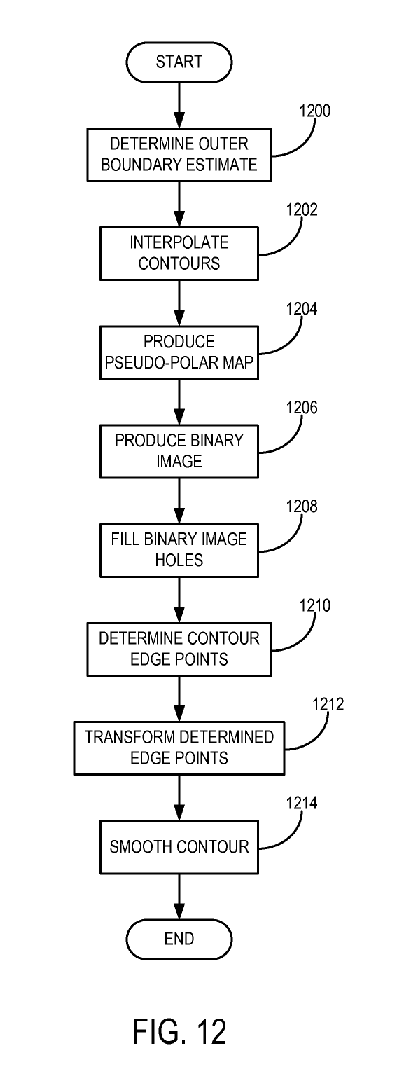

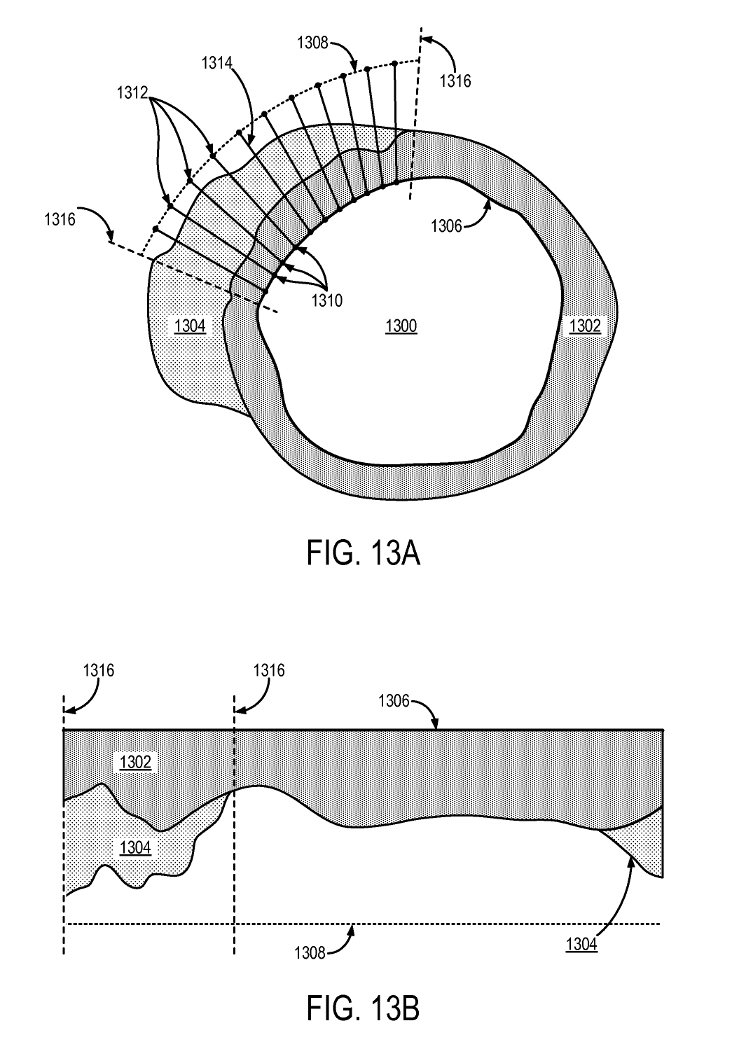

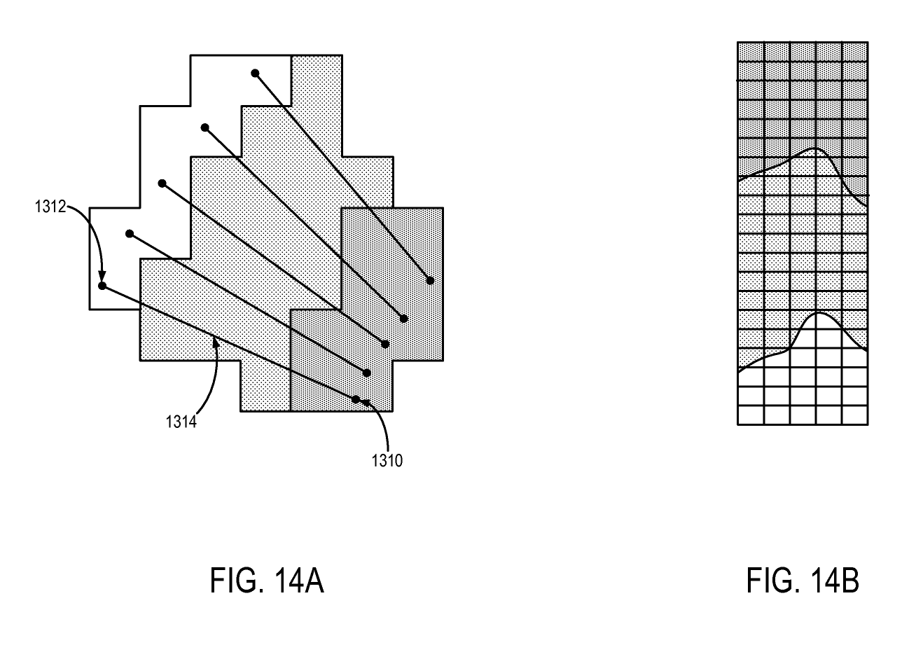

Referring now to FIG. 12, a method for producing an epicardial contour of the left ventricle beings by determining an estimate of the outer boundary of the left ventricle, as indicated at step 1200. The outer boundary estimate is calculated by dilating the endocardial boundary produced in step 1002. After the outer boundary estimate is produced, both the outer boundary and the endocardial contour are interpolated to contain the same number of points, as indicated at step 1202. In this manner, the points on the produced outer boundary estimate will correspond one-to-one with a point on the endocardial contour. Next, the pixels bounded by the outer boundary and the endocardial contour are transformed to produce a “pseudo-polar map” indicative of the ventricular wall, as indicated at step 1204. By mapping the pixels from Cartesian to “pseudo-polar” coordinates, the irregular, ring-shaped regions of interest defining an estimate of the left ventricular myocardium are transformed to rectangular images herein referred to as a “pseudo-polar map” of the ventricular wall. An illustrative example of the method for producing a pseudo-polar map is shown with reference to FIGS. 13A, 13B, 14A, and 14B, and described below in detail.

Referring first particularly to FIG. 13A, an exemplary image of a left ventricle containing generally a left ventricle blood pool region 1300, myocardial region 1302, and right ventricle blood pool region 1304, is shown. An endocardial contour 1306, such as the one produced in step 1002, is overlaid on the image, as is an outer boundary estimate 1308, such as the one produced in step 1200. As a result of the interpolation of these two exemplary contours to the same number of points in step 1202, for each point on the endocardial contour 1306 (“inner point” 1310) there is a corresponding point on the outer boundary (“outer point” 1312). Each pair of inner and outer points, 1310 and 1312, are connected with a line segment, or “scan line” 1314, having a predefined length. Exemplary scan lines 1314 have a length of 20 pixels. Those pixels in the image that overlap with a given scan line 1314 are transformed from Cartesian coordinates into polar coordinates using the appropriate transform, and this process is repeated for each scan line 1314 connecting a pair of inner and outer points, 1310 and 1312. The result of this transformation is an N×M rectangular image referred to herein as a “pseudo-polar map,” in which N is equal to the predefined scan line 1314 length, and M is equal to the number of pairs of inner and outer points, 1310 and 1312. Additionally, the top portion of the pseudo-polar map corresponds to the inner points 1310, whereas the bottom portion of the pseudo-polar map corresponds to the outer points 1312. An exemplary pseudo-polar map is shown in FIG. 13B. For illustrative purposes, only a sector of scan lines 1314 is shown, as bounded by dashed lines 1316. The corresponding portion of the pseudo-polar map is shown as bounded by the same lines 1316. In producing such pseudo-polar maps, the epicardial contour detection problem becomes simplified, as will be described below in detail. This technique is distinguished from previous methods that perform segmentation in Cartesian space.

To further describe the production of pseudo-polar maps, reference is now made to FIGS. 14A and 14B. Referring first to FIG. 14A, an exemplary region of pixels is shown, in which a series of inner and outer points, 1310 and 1312, are shown, along with their corresponding scan lines 1314. The transformation of interpolated pixels intersected by a selected scan line 1314 results in the corresponding column of pixels in the pseudo-polar map, shown in FIG. 14B. This is achieved, for example, by interpolating the pixel intensity values at equally spaced points along the scan line 1314. Exemplary methods for carrying out this interpolation step include the Matlab (The Mathworks, Inc., Natick, Mass.) function “improfile.” The applied transformation maps the Cartesian coordinates of the interpolated pixels to the pseudo-polar coordinates of the corresponding column of pixels. In this manner, subsequent calculations performed on the pseudo-polar map can be transformed back into the corresponding Cartesian coordinates, as will be discussed below.

Referring again to FIG. 12, after the pseudo-polar map has been produced using the aforementioned method, a corresponding binary image is produced, as indicated at step 1206. In this step, the binary image is produced using a 2D region growing method with seeds distributed around the endocardial contour (i.e., for each column of the pseudo-polar map). Image intensities are first normalized by the image maximum. Pixels are then added to a particular grown region if they meet a predefined intensity criterion. For example, pixels having image intensity values that differ from the mean image intensity value for the grown region by less that 0.04 are added to the current region. Each pixel in each region is then converted to a binary image pixel having a binary value of one, and those pixels not included in a region are given a binary image value of zero. In one embodiment, a determination of which pixels are added to a grown region is made relative to the previous pixels added to the region. Subsequent to the production of the binary image in this manner, a hole filling method is performed to fill in any holes in the binary image, as indicated at step 1208. Exemplary hole filling methods include the Matlab (The Mathworks, Inc., Natick, Mass.) function “imfill,” as described by P. Soille in Morphological Image Analysis: Principles and Applications, Springer-Verlag, 1999, pp. 173-174, and the closing morphological operation. After the binary image is processed to fill existing holes, the edge points for the epicardial contour are determined, as indicated at step 1210. This is achieved by selecting the end pixel for each grown region in the binary image. As stated before, the region growing is seeded from the top of each column in the pseudo-polar map; therefore, the bottom pixel in each column of the binary image having a binary image value of one is selected as the edge point of the epicardial contour along the scan line 1314.

The pixels identified as the edge points for the epicardial contour are subsequently transformed back into Cartesian coordinate space by applying the inverse transformation associated with that used to produce the pseudo-polar map, as indicated at step 1212. This inverse transformation therefore determines the (x,y) coordinates of the edge point location along the corresponding scan line 1314. In this manner, a series of points that define the epicardial contour are identified. These points are connected to produce an epicardial contour that is subsequently smoothed in step 1214. This smoothing process is the same 1D FFT based smoothing utilized in step 1002 to smooth the endocardial contour.

Referring again to FIG. 7, after the epicardial contour is produced, a determination is made at decision block 714 whether all of the desired images have been processed in accordance with the above-described segmentation method. If not, the next cardiac image is selected at step 716 and the segmentation method is repeated to produce the contours for that image. After all of the desired images have been processed, clinical cardiac parameters, such as ejection fraction (“EF”), left ventricle volume, peak ejection rate, and filling rate are next calculated from the determined contours, as indicated at step 718.

Optionally, when the segmentation of endocardial and epicardial contours by two-dimensional image processing is completed and before clinical cardiac parameters are determined, the produced contours are regularized, or “smoothed,” from three-dimensional meshes in order to provide a series of surfaces consistent with known cardiac anatomy. Each mesh is formed from all of the produced contours associated with the same cardiac phase and cardiac boundary, such as endocardial or epicardial boundary. An exemplary method of regularizing the four-dimensional shape is the calculation of two-dimensional fast Fourier transform (“FFT”) along the z-axis and cardiac phase directions simultaneously. In an embodiment of the invention, only the four lowest frequency components of each two-dimensional FFT are kept. In an alternative method, however, the contours are corrected by calculating the substantially optimal match of the detected shape with a cardiac shape model database.

The results of the four-dimensional regularization can be optionally refined by presenting the user with the option to answer a small number of questions regarding the patient's pathology. For example, the user may be presented with questions regarding whether the patient's pathology is heart failure, or ischemia. The answers to these questions may be used to tune the segmentation parameters. By way of example, the answers specify if the patient has an enlarged heart due to heart failure. This pathological information would tune the dilation (step 1200), intensity thresholds (steps 902, 910, and 1207), and ROI image size (step 900). It is contemplated that this tuning stage can also be implemented prior to performing image segmentation.

The present invention has been described in terms of one or more preferred embodiments, and it should be appreciated that many equivalents, alternatives, variations, and modifications, aside from those expressly stated, are possible and within the scope of the invention. For example, the present invention has been described with respect to an embodiment concerned with the segmentation of cardiac images. In the alternative, the segmentation method described herein can be applicable to segment images indicative of other organs, such as cross-sectional images of vessels like the internal carotid artery.

1. A method for segmenting an image depicting a subject's heart into a plurality of regions, the steps of the method comprising:
a) acquiring, with a medical imaging system, image data from the subject;
b) reconstructing, from the acquired image data, an image depicting the subject's heart;
c) identifying, in the reconstructed image, a chamber of the subject's heart, the chamber including a wall having an inner surface and an outer surface;
d) producing an inner contour indicative of the inner surface of the chamber wall, the inner contour including a plurality of inner points;
e) producing a pseudo-polar map of the chamber by:
e)i) forming a plurality of line segments of a selected length, each of the plurality of line segments extending from one of the plurality of inner points towards the outer surface of the chamber;
e)ii) mapping pixel values in the reconstructed image that lie along each of the plurality of line segments into an image matrix, each row of the image matrix corresponding to a position along the selected length of the plurality of line segments and each column of the image matrix corresponding to one of the plurality of inner points;
f) determining, from the pseudo-polar map, an outer contour indicative of the outer surface of the chamber wall; and
g) segmenting the reconstructed image using the inner and outer contours, such that a region of the reconstructed image depicting the wall of the chamber of the subject's heart is segmented from the remainder of the reconstructed image.

2. The method as recited in claim 1 in which step c) includes selecting a region of interest (ROI) that contains the chamber wall and producing an ROI image using the selected ROI by forming an image matrix including only those pixels contained in the selected ROI.

3. The method as recited in claim 2 in which step c) further includes:
c)i) producing a binary image from the ROI image;
c)ii) calculating a convex hull for each of a plurality of pixel clusters in the binary image;
c)iii) calculating a roundness metric for each calculated convex hull;
c)iv) selecting the convex hull with the largest roundness metric; and
c)v) calculating a centroid of the selected convex hull.

4. The method as recited in claim 3 in which step c) further includes thresholding the binary image such that pixel clusters containing fewer pixels than a selected threshold are removed from the binary image.

5. The method as recited in claim 2 in which step d) includes:
d)i) producing a binary image from the ROI image;
d)ii) identifying a cluster of pixels in the binary image that substantially overlap with a mask having a selected size and selected shape; and
d)iii) producing the inner contour by calculating a contour of the identified pixel clusters.

6. The method as recited in claim 5 in which step d) further includes:
d)iv) producing a binary mask by dilating the identified cluster of pixels;
d)v) producing a refined ROI image by masking the ROI image with the binary mask; and
d)vi) repeating steps d)i)-d)iii) using the refined ROI image.

7. The method as recited in claim 6 further comprising:
h) segmenting regions of the reconstructed image depicting papillary muscles and trabeculations within the chamber of the subject's heart by:
h)i) calculating a convex hull of the cluster of pixels identified in step d)ii);
h)ii) producing a blood pool binary mask from the convex hull calculated in step h)i);
h)iii) producing a segmentation mask by subtracting the blood pool binary mask and the binary mask produced in step d)iv);
h)iv) calculating a segmentation contour from the segmentation mask, the segmentation contour bounding regions in the reconstructed image that depict papillary muscles and trabeculations in the chamber of the subject's heart; and
h)v) segmenting the reconstructed image using the segmentation contour, such that regions of the reconstructed image depicting papillary muscles and trabeculations in the chamber of the subject's heart are segmented from the remainder of the reconstructed image.

8. The method as recited in claim 5 in which step d)iii) includes calculating a convex hull of the identified cluster of pixels, producing a contour from the convex hull, and smoothing the contour from the convex hull in order to produce the inner contour indicative of the inner surface of the chamber of the subject's heart.

9. The method as recited in claim 1 in which step e)i) includes:
determining an estimate of an outer contour of the chamber;
interpolating the estimate of the outer contour to produce a plurality of outer points thereon, such each of the plurality of outer points corresponds one-to-one with one of the plurality of inner points; and
forming the plurality of line segments by connecting each of the plurality of inner points with the corresponding one of the plurality of outer points.

10. The method as recited in claim 9 in which the estimate of the outer contour of the chamber is determined in step e)i) by dilating the inner contour using the selected length of the line segments.

11. The method as recited in claim 1 in which step f) includes:
f)i) producing a binary image from the pseudo-polar map;
f)ii) determining an edge point for each column in the image matrix;
f)iii) transforming the edge points into Cartesian coordinates; and
f)iv) producing a contour using the transformed edge points.

12. The method as recited in claim 11 in which step f)i) includes:
normalizing the pseudo-polar map by the maximum image intensity value therein;
selecting a seed point for each column in the image matrix;
forming a region for each column in the image matrix by including successively adjacent pixels in the column, starting from the seed point, to the region if the image intensity value for the successively adjacent pixels is greater than a threshold value; and
setting each image intensity value for the pixels in the formed regions to one, and each image intensity value for the pixels not in the formed regions to zero.

13. The method as recited in claim 12 in which step f)ii) includes selecting the edge point for each column in the image matrix as the pixel in the formed region associated with that column that is furthest from the seed point.

14. The method as recited in claim 1 in which the chamber of the subject's heart is the left ventricle.

15. The method as recited in claim 1 in which the medical imaging system is at least one of a magnetic resonance imaging (MRI) system, an x-ray computed tomography (CT) system, and an ultrasound imaging system.

16. A method for segmenting an image of a subject, the steps of the method comprising:
a) acquiring, with a medical imaging system, image data from the subject;
b) reconstructing an image from the acquired image data, the reconstructed image depicting an anatomical region having an inner surface and an outer surface;
c) producing an inner contour indicative of the inner surface of the anatomical region, the inner contour including a plurality of inner points;
d) producing a pseudo-polar map of the anatomical region by:
i) forming a plurality of line segments of a selected length, each of the plurality of line segments extending from one of the plurality of inner points towards the outer surface of the anatomical region;
ii) mapping pixel values in the reconstructed image that lie along each of the plurality of line segments into an image matrix, each row of the image matrix corresponding to a position along the selected length of the plurality of line segments and each column of the image matrix corresponding to one of the plurality of inner points;
e) determining from the pseudo-polar map, an outer contour indicative of the outer surface of the anatomical region; and
f) segmenting the reconstructed image using the inner and outer contours, such that a region of the reconstructed image depicting the anatomical region, as bounded by the inner and outer contours, is segmented from the remainder of the reconstructed image.

17. The method as recited in claim 16 in which the anatomical region is at least one of a left ventricle of the subject's heart and an internal carotid artery.

18. The method as recited in claim 16 in which step e) includes
e)i) producing a binary image from the pseudo-polar map using a region growing method, such that the binary image depicts substantially only the anatomical region as having pixel values of one;
e)ii) determining an edge point for each column in the binary image, each edge point substantially corresponding to the outer surface of the anatomical region;
e)iii) transforming the edge points into Cartesian coordinates; and
e)iv) producing a contour using the transformed edge points.

19. The method as recited in claim 16 in which step d)i) includes:
determining an estimate of an outer contour of the anatomical region;
interpolating the estimate of the outer contour to produce a plurality of outer points thereon, such each of the plurality of outer points corresponds one-to-one with one of the plurality of inner points; and
forming the plurality of line segments by connecting each of the plurality of inner points with the corresponding one of the plurality of outer points.

20. The method as recited in claim 15 in which step d)ii) includes transforming pixels in the reconstructed image that overlap with the line segments from Cartesian coordinates to polar coordinates such that the polar coordinates of the pixels in the pseudo-polar map correspond to a position along the direction of a given line segment and the inner point from which the given line segment extends.
